(19) United States
(12) Patent Application Publication
(10) Pub. No.: US 2026/0238417 A1
(43) Pub. Date: Aug. 13, 2026

(54) COMBINED UPLINK AND DOWNLINK MULTICARRIER LOAD BALANCING

(71) Applicant: TELEFONAKTIEBOLAGET ML ERICSSON (PUBL), Stockholm (SE)

(72) Inventors: Gary BOUDREAU, Kanata (CA); Stephen RAYMENT, Ottawa (CA)

(73) Assignee: TELEFONAKTIEBOLAGET ML ERICSSON (PUBL), Stockholm (SE)

(21) Appl. No.: 19/471,694

(22) PCT Filed: Apr. 5, 2023
(86) PCT No.: PCT/IB2023/053492

§ 371 Date: Oct. 2, 2025

(51) Int. Cl. H04L 5/00

(52) U.S. Cl. CPC H04L 5/0044; H04L 5/0098

(57) ABSTRACT

A method in a network node configured to communicate with a plurality of WDs in a cell using at least one of a plurality of frequency carriers is provided. The method includes determining a plurality of coverage regions based on an uplink, UL, demand and a downlink, DL, demand associated with the cell, where each coverage region is associated with one corresponding frequency carrier, determining a mapping of each of the WDs to corresponding coverage regions based on location information associated with each of the WDs, determining a ranking for the plurality of WDs based on the mapping and on priority information associated with the WDs, determining a resource configuration for the plurality of WDs in the cell based on the ranking, and receiving from and/or transmitting to a first WD of the plurality of WDs according to the resource configuration.

### TECHNICAL FIELD

The present disclosure relates to wireless communications, and in particular, to configurations for supporting combined uplink (UL) and downlink (DL) multicarrier load balancing.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

In order to meet the capacity demands of contemporary mobile networks, currently deployed 4G and 5G cellular networks are typically configured with one or more carriers across a multiplicity of frequency bands.

Due to the fact that for a given transmit power, individual carriers may provide differing areas of coverage depending on the frequency employed—i.e., high transmit frequencies incur higher levels of path loss—effective cell sizes may vary depending on the selected carrier. This problem may be particularly acute in the uplink (UL) where WD transmit power may be limited (e.g., to 100's of mW), and cannot be increased to compensate.

Furthermore, contemporary Radio Access Network (RAN) scheduling algorithms implemented in network nodes (e.g., eNB or gNB base stations) typically allocate radio resources across two or more carriers to maximize capacity of the networks. Existing load balancing algorithms may be utilized to schedule resources across multiple carriers and multiple cells that are neighboring or in close physical proximity.

However, existing solutions for load balancing across multiple carriers typically optimize downlink (DL) capacity, ignoring the impact on total capacity of UL transmissions which in some scenarios may actually degrade UL capacity.

Load balancing may assign more traffic to higher frequency, wider bandwidth frequency bands, which may optimize capacity for the DL, but ignores the fact that the UL in the higher frequency bands is “starved” at the same distance.

This problem may be particularly acute near or at the edge of cell, which often includes indoor users, which make up the bulk of mobile subscribers.

Thus, existing systems lack configurations for supporting UL and DL load balancing, e.g., in a multicarrier scenario.

### SUMMARY

Some embodiments advantageously provide methods, systems, and apparatuses for supporting UL and DL load balancing, e.g., in a multicarrier scenario.

Embodiments of the present disclosure may provide a method to schedule WDs, such as user equipment (UEs), on one or more frequency carriers in a cellular network based on both the DL and UL demand in a given cell, the target DL and UL throughputs of WDs in the cell, the DL and UL capacity of each carrier in the given cell, and the beamforming capabilities of the network node (e.g., base station) or WD.

In some embodiments, the scheduling method aims to implement the load balancing across the multiple frequency carriers to optimize a UL or a combined DL and UL metric. The metric may be based on a combination of metrics in both the DL and UL, each being configurable.

Embodiments of the present disclosure may provide improved optimization of load balancing across the DL and UL for a multiplicity of frequency band carriers, as compared to at least some existing solutions.

According to a first aspect of the present disclosure, a method in a network node configured to communicate with a plurality of WDs in a cell using at least one of a plurality of frequency carriers is provided. The method includes determining a plurality of coverage regions based on an uplink, UL, demand and a downlink, DL, demand associated with the cell, where each of the plurality of coverage regions is associated with one corresponding frequency carrier of the plurality of frequency carriers, and determining a mapping of each of the plurality of WDs to at least one corresponding coverage region of the plurality of coverage regions based on location information associated with each of the plurality of WDs. The method further includes determining a ranking for the plurality of WDs based on the mapping and on priority information associated with each of the plurality of WDs, determining a resource configuration for the plurality of WDs in the cell based on the ranking, and optionally, one or both of receiving from and transmitting to a first WD of the plurality of WDs according to the resource configuration.

According to one or more embodiments of this aspect, the determining of the plurality of coverage regions is further based on cell capacity information associated with each of the plurality of frequency carriers, and cell range information associated with each of the plurality of frequency carriers.

According to one or more embodiments of this aspect, the determining of the plurality of coverage regions includes determining, for a first frequency carrier of the plurality of frequency carriers a first uplink (UL) coverage region based on the UL demand in the cell, and a first downlink (DL) coverage region based on the DL demand in the cell, and determining, for at least one second frequency carrier of the plurality of frequency carriers at least one second uplink (UL) coverage region based on the UL demand in the cell, and at least one second downlink (DL) coverage region based on the DL demand in the cell.

According to one or more embodiments of this aspect, the method further includes causing transmission of a first scheduling indication to at least the first WD, the scheduling indication indicating the resource configuration for at least the first WD.

According to one or more embodiments of this aspect, determining the resource configuration for the plurality of WDs includes determining a highest-ranked WD of the plurality of WDs based on the ranking, determining, for the highest-ranked WD, a largest coverage region in which the highest-ranked WD is located based on the mapping, and assigning at least one first resource block of the largest coverage region to the first WD.

According to one or more embodiments of this aspect, the determining of the ranking for the plurality of WDs includes ranking the first WD of the plurality of WDs higher than another WD of the plurality of WDs based on the first WD being farther from a center of the cell compared to the other WD according to at least one of a physical distance and an electrical distance, the electrical distance being determined based on at least one reference signal associated with at least one of the first WD and the other WD.

According to one or more embodiments of this aspect, the determining of the ranking for the plurality of WDs includes ranking the first WD of the plurality of WDs higher than another WD of the plurality of WDs based on the first WD being located in fewer coverage regions compared to the other WD.

According to one or more embodiments of this aspect, the determining of the resource configuration is further based on a load balancing policy, where the load balancing policy is configured for optimizing at least one of an overall capacity of the cell, and an average throughput of the cell.

According to one or more embodiments of this aspect, the load balancing policy includes one or more of a prioritization of a DL capacity across the plurality of frequency carriers, a prioritization of a UL capacity across the plurality of frequency carriers, a prioritization of UL resources on at least one low band frequency carrier of the plurality of frequency carriers, a prioritization of DL resources on at least one mid-band frequency carrier of the plurality of frequency carriers, a prioritization of DL resources on at least one high-band frequency carrier of the plurality of frequency carriers, and/or a weighted combination of prioritizations (i.e., any two or more of the above prioritizations).

According to one or more embodiments of this aspect, determining the resource configuration includes assigning all UL resources and all DL resources on a first frequency carrier of the plurality of frequency carriers prior to activating a second frequency carrier of the plurality of frequency carriers.

According to one or more embodiments of this aspect, the method further includes determining a beamforming configuration for at least one frequency carrier, the beamforming configuration extending a range of at least one coverage region based on an additional UL capacity requirement of at least one WD located near an edge of the cell.

According to one or more embodiments of this aspect, the method further includes determining a first beamforming configuration for a first frequency carrier, where the beamforming configuration is configured to minimize interference between the first frequency carrier in the cell and the first frequency carrier in a neighboring cell, and the first beamforming configuration is orthogonal to a second beamforming configuration of the neighboring cell.

According to one or more embodiments of this aspect, the determining of the resource configuration includes one of prioritizing a DL capacity across the plurality of frequency carriers based on a neighboring cell prioritizing an UL capacity, and prioritizing the UL capacity across the plurality of frequency carriers based on the neighboring cell prioritizing the DL capacity.

According to another aspect of the present disclosure, a network node configured to communicate with a plurality of wireless devices (WDs) in a cell using at least one of a plurality of frequency carriers is provided. The network node is configured to determine a plurality of coverage regions based on an uplink, UL, demand and a downlink, DL, demand associated with the cell, where each of the plurality of coverage regions is associated with one corresponding frequency carrier of the plurality of frequency carriers, and determine a mapping of each of the plurality of WDs to at least one corresponding coverage region of the plurality of coverage regions based on location information associated with each of the plurality of WDs. The network node is further configured to determine a ranking for the plurality of WDs based on the mapping and on priority information associated with each of the plurality of WDs, determine a resource configuration for the plurality of WDs in the cell based on the ranking, and optionally, receive from and/or transmit to a first WD of the plurality of WDs according to the resource configuration.

According to one or more embodiments of this aspect, the determining of the plurality of coverage regions is further based on cell capacity information associated with each of the plurality of frequency carriers, and cell range information associated with each of the plurality of frequency carriers.

According to one or more embodiments of this aspect, the determining of the plurality of coverage regions includes determining, for a first frequency carrier of the plurality of frequency carriers a first uplink (UL) coverage region based on the UL demand in the cell, and a first downlink (DL) coverage region based on the DL demand in the cell, and determining, for at least one second frequency carrier of the plurality of frequency carriers at least one second uplink (UL) coverage region based on the UL demand in the cell, and at least one second downlink (DL) coverage region based on the DL demand in the cell.

According to one or more embodiments of this aspect, the network node is further configured to cause transmission of a first scheduling indication to at least the first WD, where the scheduling indication indicates the resource configuration for at least the first WD.

According to one or more embodiments of this aspect, determining the resource configuration for the plurality of WDs includes determining a highest-ranked WD of the plurality of WDs based on the ranking, determining, for the highest-ranked WD, a largest coverage region in which the highest-ranked WD is located based on the mapping, and assigning at least one first resource block of the largest coverage region to the first WD.

According to one or more embodiments of this aspect, the determining of the ranking for the plurality of WDs includes ranking the first WD of the plurality of WDs higher than another WD of the plurality of WDs based on the first WD being farther from a center of the cell compared to the other WD according to at least one of a physical distance and an electrical distance, the electrical distance being determined based on at least one reference signal associated with at least one of the first WD and the other WD.

According to one or more embodiments of this aspect, the determining of the ranking for the plurality of WDs includes ranking the first WD of the plurality of WDs higher than another WD of the plurality of WDs based on the first WD being located in fewer coverage regions compared to the other WD.

According to one or more embodiments of this aspect, the determining of the resource configuration is further based on a load balancing policy, the load balancing policy being configured for optimizing at least one of an overall capacity of the cell, and an average throughput of the cell.

According to one or more embodiments of this aspect, the load balancing policy includes one or more of a prioritization of a DL capacity across the plurality of frequency carriers, a prioritization of a UL capacity across the plurality of frequency carriers, a prioritization of UL resources on at least one low band frequency carrier of the plurality of frequency carriers, a prioritization of DL resources on at least one mid-band frequency carrier of the plurality of frequency carriers, a prioritization of DL resources on at least one high-band frequency carrier of the plurality of frequency carriers, and a weighted combination of prioritizations.

According to one or more embodiments of this aspect, determining the resource configuration includes assigning all UL resources and all DL resources on a first frequency carrier of the plurality of frequency carriers prior to activating a second frequency carrier of the plurality of frequency carriers.

According to one or more embodiments of this aspect, the network node is further configured to determine a beamforming configuration for at least one frequency carrier, where the beamforming configuration extends a range of at least one coverage region based on an additional UL capacity requirement of at least one WD located near an edge of the cell.

According to one or more embodiments of this aspect, the network node is further configured to determine a first beamforming configuration for a first frequency carrier, the beamforming configuration being configured to minimize interference between the first frequency carrier in the cell and the first frequency carrier in a neighboring cell, the first beamforming configuration being orthogonal to a second beamforming configuration of the neighboring cell.

According to one or more embodiments of this aspect, the determining of the resource configuration includes one of prioritizing a DL capacity across the plurality of frequency carriers based on a neighboring cell prioritizing an UL capacity, and prioritizing the UL capacity across the plurality of frequency carriers based on the neighboring cell prioritizing the DL capacity.

According to another aspect of the present disclosure, a method in a wireless communication system including a network node configured to communicate with a plurality of wireless devices, WDs, in a cell using at least one of a plurality of frequency carriers, is provided. The method includes determining a plurality of coverage regions based on an uplink, UL, demand and a downlink, DL, demand associated with the cell, each of the plurality of coverage regions being associated with one corresponding frequency carrier of the plurality of frequency carriers, determining a mapping of each of the plurality of WDs to at least one corresponding coverage region of the plurality of coverage regions based on location information associated with each of the plurality of WDs, determining a ranking for the plurality of WDs based on the mapping and on priority information associated with each of the plurality of WDs, determining a resource configuration for the plurality of WDs in the cell based on the ranking, and optionally, receiving from and/or transmitting to a first WD of the plurality of WDs according to the resource configuration.

According to one or more embodiments of this aspect, the determining of the plurality of coverage regions is further based on cell capacity information associated with each of the plurality of frequency carriers, and cell range information associated with each of the plurality of frequency carriers.

According to one or more embodiments of this aspect, the determining of the plurality of coverage regions includes determining, for a first frequency carrier of the plurality of frequency carriers a first uplink (UL) coverage region based on the UL demand in the cell, and a first downlink (DL) coverage region based on the DL demand in the cell, and determining, for at least one second frequency carrier of the plurality of frequency carriers at least one second uplink (UL) coverage region based on the UL demand in the cell, and at least one second downlink (DL) coverage region based on the DL demand in the cell.

According to one or more embodiments of this aspect, the method further includes causing transmission of a first scheduling indication to at least the first WD, the scheduling indication indicating the resource configuration for at least the first WD.

According to one or more embodiments of this aspect, determining the resource configuration for the plurality of WDs includes determining a highest-ranked WD of the plurality of WDs based on the ranking, determining, for the highest-ranked WD, a largest coverage region in which the highest-ranked WD is located based on the mapping, and assigning at least one first resource block of the largest coverage region to the first WD.

According to one or more embodiments of this aspect, the determining of the ranking for the plurality of WDs includes ranking the first WD of the plurality of WDs higher than another WD of the plurality of WDs based on the first WD being farther from a center of the cell compared to the other WD according to at least one of a physical distance and an electrical distance, the electrical distance being determined based on at least one reference signal associated with at least one of the first WD and the other WD.

According to one or more embodiments of this aspect, the determining of the ranking for the plurality of WDs includes ranking the first WD of the plurality of WDs higher than another WD of the plurality of WDs based on the first WD being located in fewer coverage regions compared to the other WD.

According to one or more embodiments of this aspect, the determining of the resource configuration is further based on a load balancing policy, the load balancing policy being configured for optimizing at least one of an overall capacity of the cell, and an average throughput of the cell.

According to one or more embodiments of this aspect, the load balancing policy includes one or more of a prioritization of a DL capacity across the plurality of frequency carriers, a prioritization of an UL capacity across the plurality of frequency carriers, a prioritization of UL resources on at least one low band frequency carrier of the plurality of frequency carriers, a prioritization of DL resources on at least one mid-band frequency carrier of the plurality of frequency carriers, a prioritization of DL resources on at least one high-band frequency carrier of the plurality of frequency carriers, and a weighted combination of prioritizations.

According to one or more embodiments of this aspect, determining the resource configuration includes assigning all UL resources and all DL resources on a first frequency carrier of the plurality of frequency carriers prior to activating a second frequency carrier of the plurality of frequency carriers.

According to one or more embodiments of this aspect, the method further includes determining a beamforming configuration for at least one frequency carrier, the beamforming configuration extending a range of at least one coverage region based on an additional UL capacity requirement of at least one WD located near an edge of the cell.

According to one or more embodiments of this aspect, the method further includes determining a first beamforming configuration for a first frequency carrier, the beamforming configuration being configured to minimize interference between the first frequency carrier in the cell and the first frequency carrier in a neighboring cell, the first beamforming configuration being orthogonal to a second beamforming configuration of the neighboring cell.

According to one or more embodiments of this aspect, the determining of the resource configuration includes one of prioritizing a DL capacity across the plurality of frequency carriers based on a neighboring cell prioritizing a UL capacity, and prioritizing the UL capacity across the plurality of frequency carriers based on the neighboring cell prioritizing the DL capacity.

According to another aspect of the present disclosure, a wireless communication system including a network node configured to communicate with a plurality of wireless devices, WDs, in a cell using at least one of a plurality of frequency carriers, is provided. The network node is configured to determine a plurality of coverage regions based on an uplink, UL, demand and a downlink, DL, demand associated with the cell, each of the plurality of coverage regions being associated with one corresponding frequency carrier of the plurality of frequency carriers, and determine a mapping of each of the plurality of WDs to at least one corresponding coverage region of the plurality of coverage regions based on location information associated with each of the plurality of WDs. The network node is further configured to determine a ranking for the plurality of WDs based on the mapping and on priority information associated with each of the plurality of WDs, determine a resource configuration for the plurality of WDs in the cell based on the ranking, and optionally, receive from and/or transmit to a first WD of the plurality of WDs according to the resource configuration.

According to one or more embodiments of this aspect, the determining of the plurality of coverage regions is further based on cell capacity information associated with each of the plurality of frequency carriers, and cell range information associated with each of the plurality of frequency carriers.

According to one or more embodiments of this aspect, the determining of the plurality of coverage regions includes determining, for a first frequency carrier of the plurality of frequency carriers a first uplink (UL) coverage region based on the UL demand in the cell, and a first downlink (DL) coverage region based on the DL demand in the cell, and determining, for at least one second frequency carrier of the plurality of frequency carriers at least one second uplink (UL) coverage region based on the UL demand in the cell, and at least one second downlink (DL) coverage region based on the DL demand in the cell.

According to one or more embodiments of this aspect, the network node is further configured to cause transmission of a first scheduling indication to at least the first WD, where the scheduling indication indicates the resource configuration for at least the first WD.

According to one or more embodiments of this aspect, determining the resource configuration for the plurality of WDs includes determining a highest-ranked WD of the plurality of WDs based on the ranking, determining, for the highest-ranked WD, a largest coverage region in which the highest-ranked WD is located based on the mapping, and assigning at least one first resource block of the largest coverage region to the first WD.

According to one or more embodiments of this aspect, the determining of the ranking for the plurality of WDs includes ranking the first WD of the plurality of WDs higher than another WD of the plurality of WDs based on the first WD being farther from a center of the cell compared to the other WD according to at least one of a physical distance and an electrical distance, the electrical distance being determined based on at least one reference signal associated with at least one of the first WD and the other WD.

According to one or more embodiments of this aspect, the determining of the ranking for the plurality of WDs includes ranking the first WD of the plurality of WDs higher than another WD of the plurality of WDs based on the first WD being located in fewer coverage regions compared to the other WD.

According to one or more embodiments of this aspect, the determining of the resource configuration is further based on a load balancing policy, where the load balancing policy is configured for optimizing at least one of an overall capacity of the cell, and an average throughput of the cell.

According to one or more embodiments of this aspect, the load balancing policy includes one or more of a prioritization of a DL capacity across the plurality of frequency carriers, a prioritization of an UL capacity across the plurality of frequency carriers, a prioritization of UL resources on at least one low band frequency carrier of the plurality of frequency carriers, a prioritization of DL resources on at least one mid-band frequency carrier of the plurality of frequency carriers, a prioritization of DL resources on at least one high-band frequency carrier of the plurality of frequency carriers, and a weighted combination of prioritizations.

According to one or more embodiments of this aspect, determining the resource configuration includes assigning all UL resources and all DL resources on a first frequency carrier of the plurality of frequency carriers prior to activating a second frequency carrier of the plurality of frequency carriers.

According to one or more embodiments of this aspect, the network node is further configured to determine a beamforming configuration for at least one frequency carrier, where the beamforming configuration extends a range of at least one coverage region based on an additional UL capacity requirement of at least one WD located near an edge of the cell.

According to one or more embodiments of this aspect, the network node is further configured to determine a first beamforming configuration for a first frequency carrier, the beamforming configuration being configured to minimize interference between the first frequency carrier in the cell and the first frequency carrier in a neighboring cell, where the first beamforming configuration is orthogonal to a second beamforming configuration of the neighboring cell.

According to one or more embodiments of this aspect, the determining of the resource configuration includes one of prioritizing a DL capacity across the plurality of frequency carriers based on a neighboring cell prioritizing a UL capacity, and prioritizing the UL capacity across the plurality of frequency carriers based on the neighboring cell prioritizing the DL capacity.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for supporting combined UL and DL multicarrier load balancing configurations according to some embodiments of the present disclosure;

FIG. 8 is a flowchart of an example process in a wireless communication system for supporting combined UL and DL multicarrier load balancing configurations according to some embodiments of the present disclosure;

FIG. 9 is a graph illustrating simulated metrics for example load balancing configurations, according to existing systems;

FIG. 10 is a diagram illustrating an example mapping of UL and DL capacity to coverage regions according to one or more embodiments of the present disclosure;

FIG. 11 is a diagram illustrating another example mapping of UL and DL capacity to coverage regions according to one or more embodiments of the present disclosure; and

FIG. 12 is a diagram illustrating another example mapping of UL and DL capacity to coverage regions according to one or more embodiments of the present disclosure.

### DETAILED DESCRIPTION

Before describing in detail example embodiments, it is noted that the embodiments reside primarily in combinations of apparatus components and processing steps related to supporting combined UL and DL multicarrier load balancing configurations. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), a cloud node, a core node, a centralized unit (CU) or virtual CU (vCU) element of a cloud-based radio access network (RAN) architecture, a node configured to run an rAPP and/or xAPP, etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide methods and apparatuses for supporting combined UL and DL multicarrier load balancing configurations.

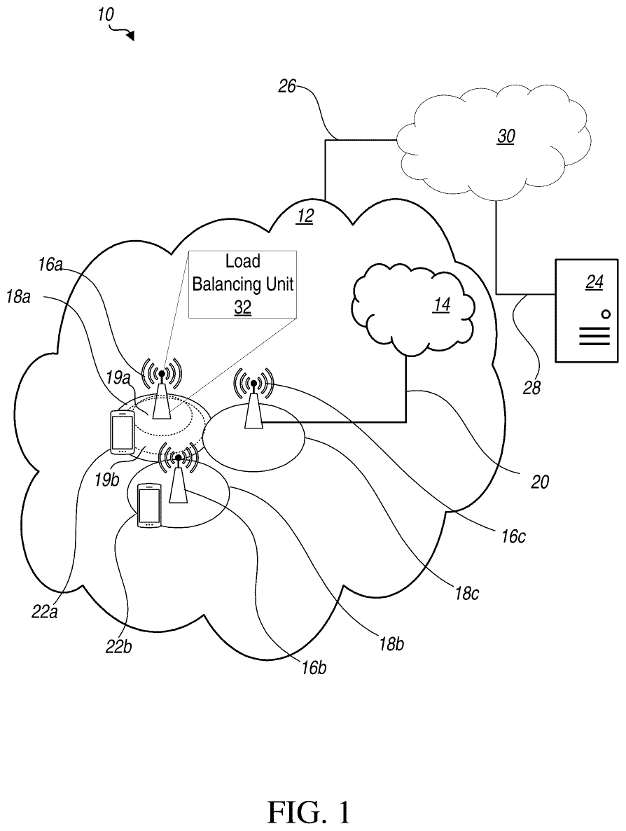

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding cell 18a, 18b, 18c (referred to collectively as cells 18). Each network node 16a, 16b, 16c is connectable to the core network 14 over a wired or wireless connection 20. In some embodiments, a network node 16 may also correspond to one or more of a cloud-based node, a core node, etc.

A first wireless device (WD) 22a located in cell 18a is configured to wirelessly connect to, or be paged by, the corresponding network node 16a. A second WD 22b in cell 18b is wirelessly connectable to the corresponding network node 16b.

Cell 18a may include one or more corresponding coverage regions (CRs) 19a, 19b, etc. (referred to collectively as coverage areas 19), which may be at least partially overlapping within the cell. For example, a WD 22a may be located in a single coverage region 19a of cell 18a, or may be located in multiple coverage areas, e.g., an overlapping portion of coverage region 19a and coverage region 19b of cell 18a. Similarly, cell 18b may include one or more corresponding coverage regions 19, cell 18c may include one or more corresponding coverage regions 19, etc.

While a plurality of WDs 22a, 22b (collectively referred to as wireless devices 22) are illustrated in this example, the disclosed embodiments are equally applicable to a situation where a sole WD 22 is in the coverage region 19 or where a sole WD 22 is connecting to the corresponding network node 16. Note that although only two WDs 22, three network nodes 16, three cells 18, and two coverage regions 19 are shown for convenience, the communication system may include many more WDs 22 and network nodes 16 with corresponding cells 18 and coverage regions 19.

It is also contemplated that in some embodiments, some network nodes 16 may correspond to access points and/or distributed units (DUs) associated with cells 18 and/or coverage regions 19, while other network nodes 16 may correspond to one or more of centralized units (CUs), cloud-based nodes, core nodes, etc., which may be in communication with and/or configured to control one or more aspects of a plurality of network nodes 16 (e.g., a CU or vCU network node 16 configured to manage load balancing policies for one or more DU network nodes 16, WDs 22, cells 18, and/or coverage regions 19).

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a load balancing unit 32 which is configured for supporting combined UL and DL multicarrier load balancing configurations.

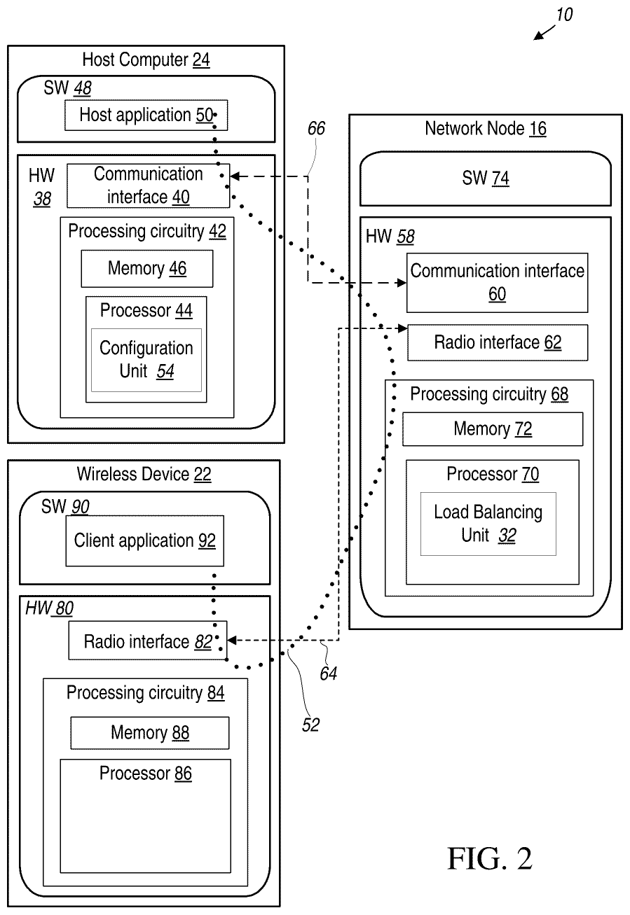

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Configuration unit 54 configured to enable the service provider to observe/monitor/control/transmit to/receive from/etc. the network node 16 and or the wireless device 22, such as for supporting combined UL and DL multicarrier load balancing configurations. For example, in some embodiments, the host computer 24 and/or configuration unit 54 may provide one or more load balancing functionalities, e.g., instead of or in addition to those functionalities provided by a network node 16 and/or load balancing unit 32.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a cell 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include load balancing unit 32 configured for supporting combined UL and DL multicarrier load balancing configurations.

The communication system 10 further includes the WD 22 already referred to. The WD 22 may have hardware 80 that may include a radio interface 82 configured to set up and maintain a wireless connection 64 with a network node 16 serving a cell 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc. ; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as load balancing unit 32, and configuration unit 54 as being within a respective processor, it is contemplated that these units may be implemented such that a portion of the unit is stored in a corresponding memory within the processing circuitry. In other words, the units may be implemented in hardware or in a combination of hardware and software within the processing circuitry.

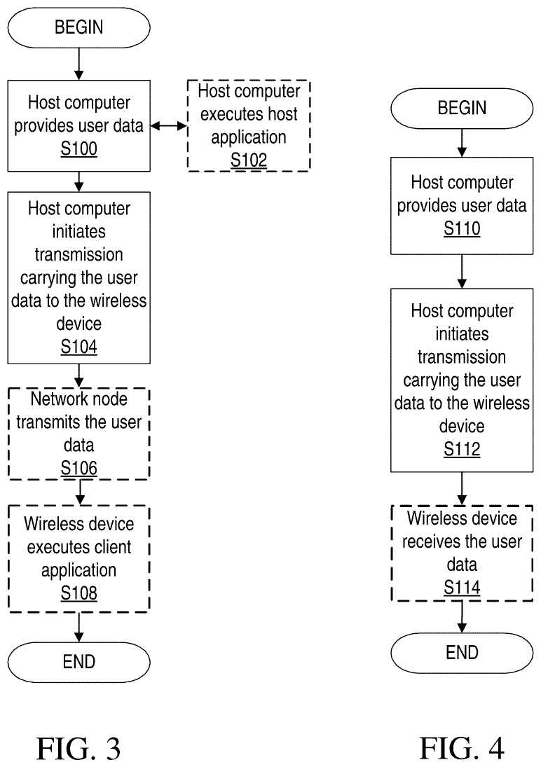

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

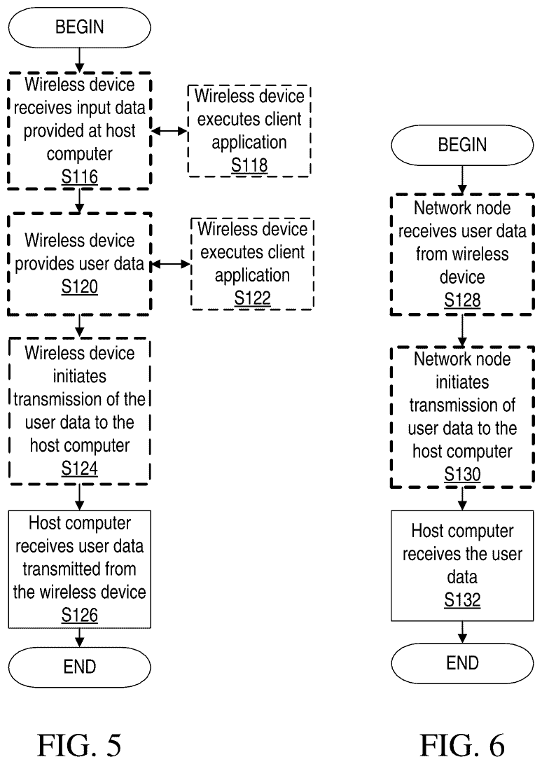

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

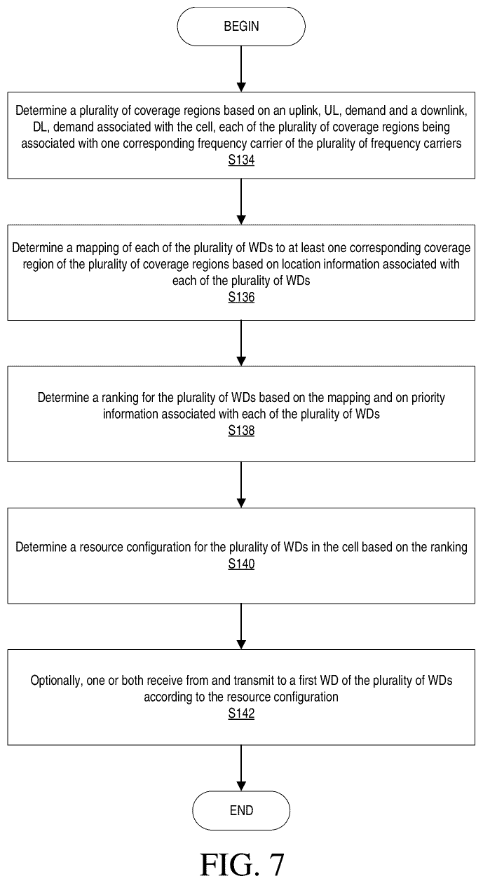

FIG. 7 is a flowchart of an example process in a network node 16 for supporting combined UL and DL multicarrier load balancing configurations. One or more blocks described herein may be performed by one or more elements of network node 16 such as by one or more of processing circuitry 68 (including the load balancing unit 32), processor 70, radio interface 62 and/or communication interface 60. Network node 16 is configured to determine (Block S134) a plurality of coverage regions 19 based on an uplink, UL, demand and a downlink, DL, demand associated with the cell 18, each of the plurality of coverage regions 19 being associated with one corresponding frequency carrier of the plurality of frequency carriers. Network node 16 is configured to determine (Block S136) a mapping of each of the plurality of WDs 22 to at least one corresponding coverage region 19 of the plurality of coverage regions 19 based on location information associated with each of the plurality of WDs 22. Network node 16 is configured to determine (Block S138) a ranking for the plurality of WDs 22 based on the mapping and on priority information associated with each of the plurality of WDs 22. Network node 16 is configured to determine (Block S140) a resource configuration for the plurality of WDs 22 in the cell 18 based on the ranking. Network node 16 is configured to, optionally, receive from and/or transmitting to (Block S142) a first WD 22 of the plurality of WDs 22 according to the resource configuration.

In some embodiments, the determining of the plurality of coverage regions 19 is further based on cell 18 capacity information associated with each of the plurality of frequency carriers, and cell 18 range information associated with each of the plurality of frequency carriers.

In some embodiments, the determining of the plurality of coverage regions 19 includes determining, for a first frequency carrier of the plurality of frequency carriers a first uplink (UL) coverage region 19 based on the UL demand in the cell 18, and a first downlink (DL) coverage region 19 based on the DL demand in the cell 18, and determining, for at least one second frequency carrier of the plurality of frequency carriers at least one second uplink (UL) coverage region 19 based on the UL demand in the cell 18, and at least one second downlink (DL) coverage region 19 based on the DL demand in the cell 18.

In some embodiments, the network node 16 is further configured to cause transmission of a first scheduling indication to at least the first WD 22, where the scheduling indication indicates the resource configuration for at least the first WD 22.

In some embodiments, determining the resource configuration for the plurality of WDs 22 includes determining a highest-ranked WD 22 of the plurality of WDs 22 based on the ranking, determining, for the highest-ranked WD 22, a largest coverage region 19 in which the highest-ranked WD 22 is located based on the mapping, and assigning at least one first resource block of the largest coverage region 19 to the first WD 22.

In some embodiments, the determining of the ranking for the plurality of WDs 22 includes ranking the first WD 22 of the plurality of WDs 22 higher than another WD 22 of the plurality of WDs 22 based on the first WD 22 being farther from a center of the cell 18 compared to the other WD 22 according to at least one of a physical distance and an electrical distance, the electrical distance being determined based on at least one reference signal associated with at least one of the first WD 22 and the other WD 22.

In some embodiments, the determining of the ranking for the plurality of WDs 22 includes ranking the first WD 22 of the plurality of WDs 22 higher than another WD 22 of the plurality of WDs 22 based on the first WD 22 being located in fewer coverage regions 19 compared to the other WD 22.

In some embodiments, the determining of the resource configuration is further based on a load balancing policy, the load balancing policy being configured for optimizing at least one of an overall capacity of the cell 18, and an average throughput of the cell 18.

In some embodiments, the load balancing policy includes one or more of a prioritization of a DL capacity across the plurality of frequency carriers, a prioritization of a UL capacity across the plurality of frequency carriers, a prioritization of UL resources on at least one low band frequency carrier of the plurality of frequency carriers, a prioritization of DL resources on at least one mid-band frequency carrier of the plurality of frequency carriers, a prioritization of DL resources on at least one high-band frequency carrier of the plurality of frequency carriers, and a weighted combination of prioritizations.

In some embodiments, determining the resource configuration includes assigning all UL resources and all DL resources on a first frequency carrier of the plurality of frequency carriers prior to activating a second frequency carrier of the plurality of frequency carriers.

In some embodiments, the network node 16 is further configured to determine a beamforming configuration for at least one frequency carrier, where the beamforming configuration extends a range of at least one coverage region 19 based on an additional UL capacity requirement of at least one WD 22 located near an edge of the cell 18.

In some embodiments, the network node 16 is further configured to determine a first beamforming configuration for a first frequency carrier, the beamforming configuration being configured to minimize interference between the first frequency carrier in the cell 18 and the first frequency carrier in a neighboring cell 18, the first beamforming configuration being orthogonal to a second beamforming configuration of the neighboring cell 18.

In some embodiments, the determining of the resource configuration includes one of prioritizing a DL capacity across the plurality of frequency carriers based on a neighboring cell 18 prioritizing an UL capacity, and prioritizing the UL capacity across the plurality of frequency carriers based on the neighboring cell 18 prioritizing the DL capacity.

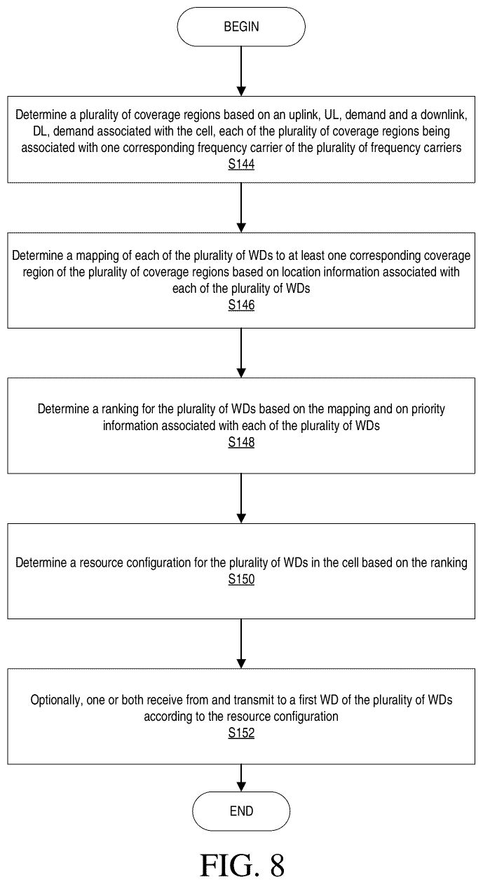

FIG. 8 is a flowchart of an example process in a wireless communication system including a network node 16 and wireless device 22 according to some embodiments of the present disclosure for supporting combined UL and DL multicarrier load balancing configurations. One or more blocks described herein may be performed by one or more elements of network node 16 such as by one or more of processing circuitry 68 (including the load balancing unit 32), processor 70, radio interface 62 and/or communication interface 60. One or more blocks described herein may be performed by one or more elements of wireless device 22 such as by one or more of processing circuitry 84, processor 86, radio interface 82 and/or communication interface 60. Network node 16 is configured to determine (Block S144) a plurality of coverage regions 19 based on an uplink, UL, demand and a downlink, DL, demand associated with the cell 18, each of the plurality of coverage regions 19 being associated with one corresponding frequency carrier of the plurality of frequency carriers. Network node 16 is configured to determine (Block S146) a mapping of each of the plurality of WDs 22 to at least one corresponding coverage region 19 of the plurality of coverage regions 19 based on location information associated with each of the plurality of WDs 22. Network node 16 is configured to determine (Block S148) a ranking for the plurality of WDs 22 based on the mapping and on priority information associated with each of the plurality of WDs 22. Network node 16 is configured to determine (Block S150) a resource configuration for the plurality of WDs 22 in the cell 18 based on the ranking. Network node 16 is configured to, optionally, receive from and/or transmit to (Block S152) a first WD 22 of the plurality of WDs 22 according to the resource configuration.

In some embodiments, the determining of the plurality of coverage regions 19 is further based on cell 18 capacity information associated with each of the plurality of frequency carriers, and cell 18 range information associated with each of the plurality of frequency carriers.

In some embodiments, the determining of the plurality of coverage regions 19 includes determining, for a first frequency carrier of the plurality of frequency carriers a first uplink (UL) coverage region 19 based on the UL demand in the cell 18, and a first downlink (DL) coverage region 19 based on the DL demand in the cell 18, and determining, for at least one second frequency carrier of the plurality of frequency carriers at least one second uplink (UL) coverage region 19 based on the UL demand in the cell 18, and at least one second downlink (DL) coverage region 19 based on the DL demand in the cell 18.

In some embodiments, the network node 16 is further configured to cause transmission of a first scheduling indication to at least the first WD 22, where the scheduling indication indicates the resource configuration for at least the first WD 22.

In some embodiments, determining the resource configuration for the plurality of WDs 22 includes determining a highest-ranked WD 22 of the plurality of WDs 22 based on the ranking, determining, for the highest-ranked WD 22, a largest coverage region 19 in which the highest-ranked WD 22 is located based on the mapping, and assigning at least one first resource block of the largest coverage region 19 to the first WD 22.

In some embodiments, the determining of the ranking for the plurality of WDs 22 includes ranking the first WD 22 of the plurality of WDs 22 higher than another WD 22 of the plurality of WDs 22 based on the first WD 22 being farther from a center of the cell 18 compared to the other WD 22 according to at least one of a physical distance and an electrical distance, the electrical distance being determined based on at least one reference signal associated with at least one of the first WD 22 and the other WD 22.

In some embodiments, the determining of the ranking for the plurality of WDs 22 includes ranking the first WD 22 of the plurality of WDs 22 higher than another WD 22 of the plurality of WDs 22 based on the first WD 22 being located in fewer coverage regions 19 compared to the other WD 22.

In some embodiments, the determining of the resource configuration is further based on a load balancing policy, where the load balancing policy is configured for optimizing at least one of an overall capacity of the cell 18, and an average throughput of the cell 18.

In some embodiments, the load balancing policy includes one or more of a prioritization of a DL capacity across the plurality of frequency carriers, a prioritization of an UL capacity across the plurality of frequency carriers, a prioritization of UL resources on at least one low band frequency carrier of the plurality of frequency carriers, a prioritization of DL resources on at least one mid-band frequency carrier of the plurality of frequency carriers, a prioritization of DL resources on at least one high-band frequency carrier of the plurality of frequency carriers, and a weighted combination of prioritizations.

In some embodiments, determining the resource configuration includes assigning all UL resources and all DL resources on a first frequency carrier of the plurality of frequency carriers prior to activating a second frequency carrier of the plurality of frequency carriers.

In some embodiments, the network node 16 is further configured to determine a beamforming configuration for at least one frequency carrier, where the beamforming configuration extends a range of at least one coverage region 19 based on an additional UL capacity requirement of at least one WD 22 located near an edge of the cell 18.

In some embodiments, the network node 16 is further configured to determine a first beamforming configuration for a first frequency carrier, the beamforming configuration being configured to minimize interference between the first frequency carrier in the cell 18 and the first frequency carrier in a neighboring cell 18, where the first beamforming configuration is orthogonal to a second beamforming configuration of the neighboring cell 18.

In some embodiments, the determining of the resource configuration includes one of prioritizing a DL capacity across the plurality of frequency carriers based on a neighboring cell 18 prioritizing a UL capacity, and prioritizing the UL capacity across the plurality of frequency carriers based on the neighboring cell 18 prioritizing the DL capacity.

Having described the general process flow of arrangements of the disclosure and having provided examples of hardware and software arrangements for implementing the processes and functions of the disclosure, the sections below provide details and examples of arrangements for supporting combined UL and DL multicarrier load balancing configurations.

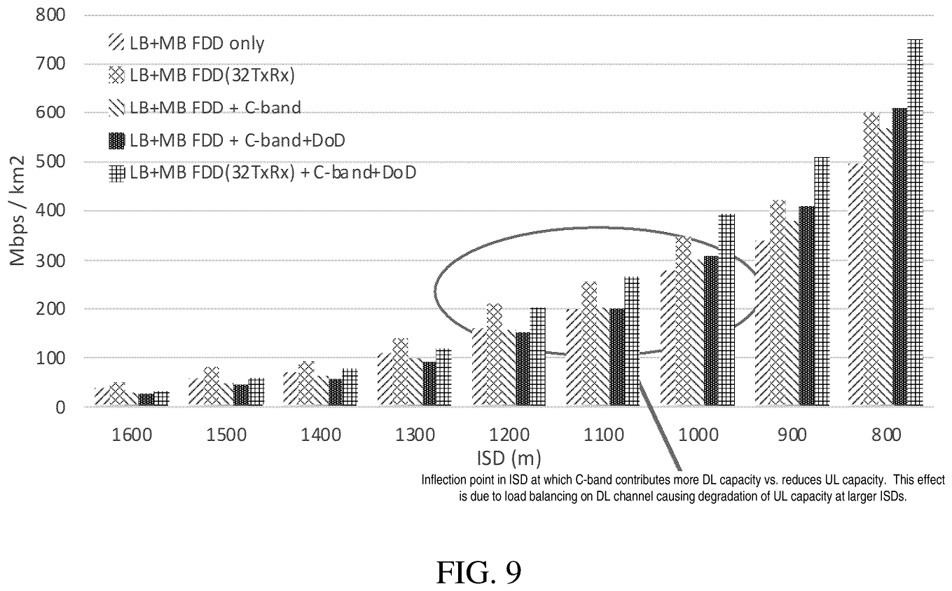

FIG. 9 is a graph which illustrates an example of how DL-only based load balancing may degrade UL capacity, as compared to embodiments of the present disclosure using combined UL and DL multicarrier load balancing configurations. As illustrated in FIG. 9, adding more mid-band time division duplex (TDD) spectrum, while observing only its DL, may worsen UL aggregate performance, in some cases. In the example of FIG. 9, an inflection point occurs around ISD=1100 m, at which the C-band contributes more DL capacity vs. reduces UL capacity. This effect may be due to load balancing on the DL channel causing degradation of UL capacity at larger ISDs.

### Embodiment 1

In an example embodiment of the present disclosure, referred to herein as “Embodiment 1,” a method is provided for implementing load balancing across multiple carriers to optimize/target/observe a combined DL and UL metric. The metric is based on each WD 22 achieving a target throughput (e.g., DL and/or UL) with a defined confidence level (e.g., 10 Mbps 95% of the time on the DL, 1 Mbps 95% of the time on the UL, etc.). The load balancing may be configured based on a metric derived from a combination of one or more KPIs/metrics in either or both the DL and UL, each with a configurable threshold. The selected metrics or KPIs may include one of or a combination of overall capacity, average throughput, reference signal receive power (RSRP), reference signal receive quality (RSRQ), reference signal to interference and noise ratio (RS-SINR), signal-to-leakage-plus-noise ratio (SLNR), location of the WD 22, and/or other designated metrics. The KPIs/metrics may be computed and/or determined in the network node 16 (e.g., an eNB/gNB and/or a cloud server), the host computer 24, and/or in the WD 22, or a combination of computation in the cloud (e.g., host computer 24 and/or network node 16), eNB/gNB (network node 16), and/or WD 22, such as by using existing CSI type messaging, such as CSI-RS, SRS, RSRP, RS-SINR, RSRQ signals, etc.

In some embodiments, the capacity of the DL and UL within a given cell 18 may be optimized (i.e., targeted for improvement) jointly. WDs 22 being served by the cell 18/network node 16 may be assigned physical layer resource blocks (RBs) (e.g., by a network node 16) in one or more of the carrier frequencies available to the cell 18. For example, considering the DL, for each carrier frequency band j available in the cell 18, a coverage region 19 CR(downlink_j) may be defined that meets a fraction d_j of the total capacity demand D of the DL in the cell. To ensure that the total capacity demand is met, the condition that the sum of d_j over all j, is greater than D may be configured as a target to be met. A similar partitioning of the UL capacity demand across each frequency band j may also be defined in terms of the UL coverage regions 19 CR(uplink_j).

Thus, some embodiments may optimize (i.e., target for improvement) a combined metric across a set of multiple carriers in an individual cell 18. The assignment of DL and UL resources may employ all or a subset of the available set of carriers, depending on the location of the WD 22 relative to each CR 19. For example, WDs 22 that are located within all coverage regions 19 (e.g., close to the cell 18 center) may be assigned resources in each carrier, whereas those WDs 22 that are closer to the cell 18 edge may only be assigned resources in the CR available at the cell 18 edge.

In some embodiments, for each WD 22, sufficient physical layer RBs may be assigned to DL and UL coverage regions 19 (e.g., correspond to the coverage area of each carrier) to ensure that it can meet the targeted DL and UL demand for the WDs 22 assigned to the carrier.

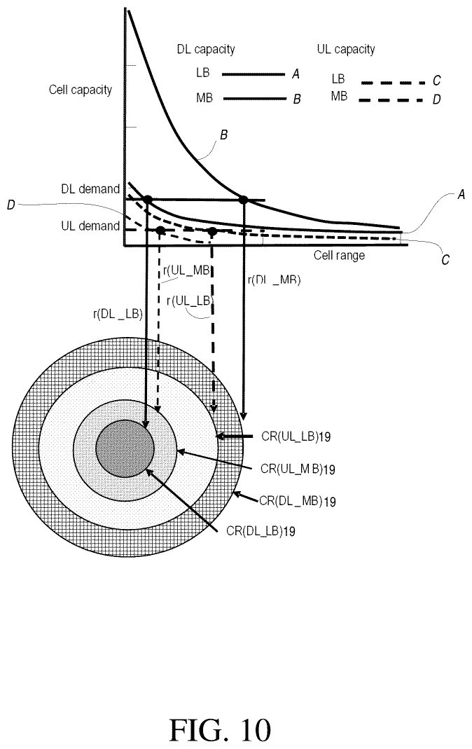

FIG. 10 is a diagram which illustrates an example configuration according to some embodiments, such as “Embodiment 1”, of the present disclosure. In this illustrative example with two carriers, the top of the figure conceptually captures the differing capacity of the UL and DL for the two different carriers—i.e., a low band (LB) carrier and a mid-band (MB) carrier-versus increasing cell range of a cell 18. For each of the given UL and DL target capacity demand levels, the available DL and UL capacity will be met for cell ranges less than the cut-off for the available capacity. These ranges map into coverage regions 19 in the cell 18 as illustrated at the bottom of FIG. 10. Specifically, the DL LB and DL MB frequency bands meet the required demand for cell ranges less than or equal to r(DL_LB) and r(DL_MB) respectively, defining the coverage regions 19 CR(DL_LB) 19 and CR(DL_MB) 19 in the bottom of FIG. 10. Similarly, for the UL LB and UL MB frequency bands, the required demand is met for cell ranges less than or equal to r(UL_LB) and r(UL_MB) respectively, defining the coverage regions 19 CR(UL_LB) 19 and CR(UL_MB) 19. In FIG. 10, the CR regions 19 are illustrated for a physically defined region; however, it should be noted that such regions can also be virtual, representing electrical distance in terms of signal loss for example.

Noting that the overall demand D, for the DL and UL, may increase with the number of WDs 22 per cell 18, or user density per cell 18, as well as the target throughput per WD 22, RBs across all the carriers in the cell 18, may need to be assigned to each WD 22 based on a priority derived from, e.g., the selection of a load balancing policy (e.g., by network node 16).

Embodiments of the present disclosure may enable the network (e.g., a network node 16, a host computer 24, a cloud node, a core node, etc.) to select one of several possible policies that have one or more of the following characteristics:
Ranks or prioritizes the order of WDs 22 to which DL and UL resources may be assigned by network node(s) 16. The ranking may be determined based on the location of the WDs 22 (i.e., which CRs 19 each WD 22 is located within), a priority of the transmission, a service or use case that the WD 22 is supporting, etc. The priority itself may be configured by the network node 16, e.g., through the use of QCIs associated with NSSAIs (network slice identifiers), radio resource partitions (RRP), and/or other network parameters.
Starting with the highest ranked WD 22, for each WD 22, assign DL and UL resources according to a policy to optimize both DL and UL capacity within the CRs 19 for which the WD 22 has coverage. As a general principle, the assignment of RBs to a given WD 22 may start with the largest CR 19 that the WD 22 is present within. In the context of this principle, several possible policy variations are listed below, which may be implemented in configuration information stored in/received by network node 16:
A policy to prioritize DL capacity across available CR 19 carriers. Each WD 22 in the prioritized order may be assigned DL resources on one or more CR 19 carriers to achieve its target DL throughput and capacity;
A policy to prioritize UL capacity across available CR 19 carriers; Each WD 22 in the prioritized order is assigned UL resources on one or more carriers to achieve its target UL throughput and capacity.
A policy that allows a weighted penalization of the capacity in both the UL and DL;
A policy that prioritizes UL resources on low band carriers and DL resources on mid-band or high band carriers; and/or
A policy to maximize energy savings by reducing the number of carriers transmitting at any given time, for example by utilizing all UL and DL resources on a first carrier prior to activating a second carrier.

For a given WD 22, if there are insufficient RBs available on either the UL or the DL to meet both the UL and DL demand simultaneously, a policy can be adopted (e.g., by network node 16) to accept a level of performance below the target level for the given WD 22 (i.e. reduce its priority) or rebalance available resources across all WDs 22 and accept an overall reduced throughput per WD. This approach can be adopted for any of the policies noted above.

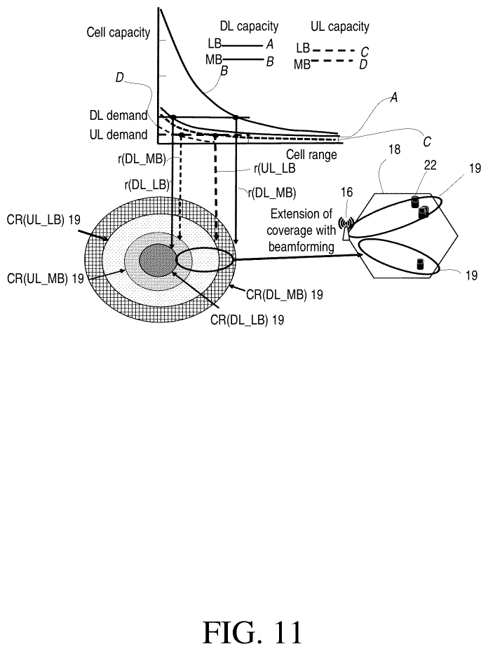

For the coverage regions 19 illustrated in FIG. 10, it has been assumed that omni directional antenna are employed. As an extension to Embodiment 1, the coverage region 19 of any of the DL or UL carriers may be modified through use of directional antennas or beamforming to extend the CR 19 beyond the nominal omni coverage region 19. An example of such a configuration is illustrated in the diagram of FIG. 11, in which the network node 16 (e.g., base station) employs beamforming during MB-TDD UL transmissions to provide coverage and capacity beyond the CR 19 available with an omni antenna and, by doing so, may provide additional UL capacity to WDs 22 situated near the cell 18 edge. Note that for MB TDD transmissions, it may be possible to switch the antenna gain between the UL and DL transmissions subframes of the TDD frame.

### Embodiment 2

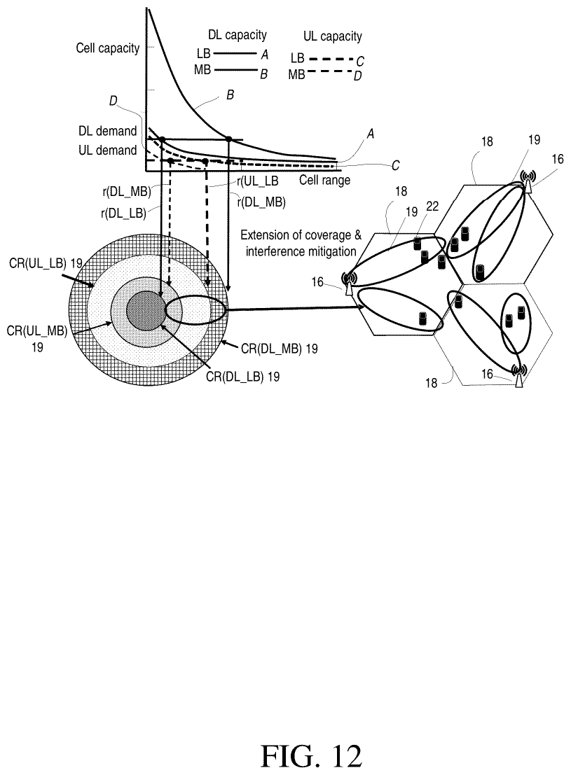

A second example embodiment of the present disclosure, “Embodiment 2,” employs one or more methods described above with respect to Embodiment 1 across one or more carriers in each of one or more neighboring or proximate cells 18 in the network 12. The beamforming selected in each carrier coverage region 19 is selected (e.g., by network node 16, by a cloud node, etc.) to minimize interference between the CR 19 of common carriers active in each of the neighboring cells 18. The set of proximate cells 18 may be selected by the network node 16 based on a number of criteria, such as inter-site distance (ISD) or signal-to interference ratios between cells 18. An example of such an embodiment is illustrated in the diagram of FIG. 12. The beamforming in a CR 19 is selected by network node 16 to not only meet the capacity demand for the carrier CR 19, but also to be orthogonal to beamforming selected by neighboring cells 18 to provide coverage to WDs 22 in the neighboring cells 18. In order to coordinate the orthogonalization of the beams between cells 18, the exchange of spatial beamforming information between cells 18 will need to be achieved through one of several possible methods such as a direct link between the network nodes 16 (e.g., gNBs), such as using an Xn interface, or through connection(s) to a cloud server (e.g., a vCU), such as hosted in a host computer 24 or other network node 16.

In some embodiments, such as Embodiment 2, the selected policies may be the same or different between neighboring cells 18. For example, one cell 18 may choose a policy to prioritize DL capacity across available carriers, whereas neighboring cells 18 may choose a policy to prioritize UL capacity. Such an approach may be used by network node 16, for example, to reduce DL intercell interference from neighboring cells 18 on the target cell 18, since fewer DL RBs would be used in the carriers of neighboring cells 18.

As an extension to Embodiment 2, the neighboring cells 18 may be configured as part of a heterogenous overlay such as use of small cells 18 within the coverage of macros cells 18. In this scenario, the small cells 18 may be SCells within a secondary cell group (SCG) of the Master Cell Group (MCG), or SCells to the PCell (CA), supported by the macro cell 18.

### Embodiment 3

According to another embodiment of the present disclosure, “Embodiment 3,” the network node 16 may be configured to employ different radio resource partitions (RRPs) spanning multiple carriers or cells 18. Typically, DL or UL resource allocation policies may be defined separately and the Radio Resource Partition algorithms may only compare usage against those separate DL or UL policies. By comparison, in some embodiments of the present disclosure, such as Embodiment 3, a joint DL and UL resource allocation policy may be performed (e.g., by network node 16) across RRPs for both the UL and DL performance metrics described above. This approach may provide improved performance for both UL and DL network slices, as compared to some existing methods.

In some embodiments, the load balancing functions described herein may be implemented in a vCU element of a Cloud RAN architecture, e.g., in a network node 16 configured to operate as a core node with vCU functionality, in a host computer 24 which serves as a Cloud RAN node with vCU functionality, etc.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
CQI cell quality indicator
CR coverage region
DL downlink
LB lowband
MB midband
MCG master cell group
NSSAI network slice selection assistance information
QCI QoS class identifier
RB resource block
RSRP reference signal received power
RSRQ reference signal received quality
SCG secondary cell group
SINR signal to interference noise ratio
SRS sounding reference signal
UL uplink

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a plurality of wireless devices, WDs, in a cell using at least one of a plurality of frequency carriers, the method comprising:
determining a plurality of coverage regions based on an uplink, UL, demand and a downlink, DL, demand associated with the cell, each of the plurality of coverage regions being associated with one corresponding frequency carrier of the plurality of frequency carriers;
determining a mapping of each of the plurality of WDs to at least one corresponding coverage region of the plurality of coverage regions based on location information associated with each of the plurality of WDs;
determining a ranking for the plurality of WDs based on the mapping and on priority information associated with each of the plurality of WDs;
determining a resource configuration for the plurality of WDs in the cell based on the ranking; and
one or both of receiving from and transmitting to a first WD of the plurality of WDs according to the resource configuration.

2. The method of claim 1, wherein the determining of the plurality of coverage regions is further based on:
cell capacity information associated with each of the plurality of frequency carriers; and
cell range information associated with each of the plurality of frequency carriers.

3. The method of claim 1, wherein the determining of the plurality of coverage regions includes:
determining, for a first frequency carrier of the plurality of frequency carriers:
a first uplink (UL) coverage region based on the UL demand in the cell; and
a first downlink (DL) coverage region based on the DL demand in the cell; and
determining, for at least one second frequency carrier of the plurality of frequency carriers:
at least one second uplink (UL) coverage region based on the UL demand in the cell; and
at least one second downlink (DL) coverage region based on the DL demand in the cell.

4. The method of claim 1, wherein the method further comprises causing transmission of a first scheduling indication to at least the first WD, the scheduling indication indicating the resource configuration for at least the first WD.

5. The method of claim 1, wherein determining the resource configuration for the plurality of WDs includes:
determining a highest-ranked WD of the plurality of WDs based on the ranking;
determining, for the highest-ranked WD a largest coverage region in which the highest-ranked WD is located based on the mapping; and
assigning at least one first resource block of the largest coverage region to the first WD.

6. The method of claim 1, wherein the determining of the ranking for the plurality of WDs includes:
ranking the first WD of the plurality of WDs higher than another WD of the plurality of WDs based on the first WD being farther from a center of the cell compared to the other WD according to a physical distance.

7. The method of claim 1, wherein the determining of the ranking for the plurality of WDs includes:
ranking the first WD of the plurality of WDs higher than another WD of the plurality of WDs based on the first WD being located in fewer coverage regions compared to the other WD.

8. The method of claim 1, wherein the determining of the resource configuration is further based on a load balancing policy, the load balancing policy being configured for optimizing at least one of:
an overall capacity of the cell; and
an average throughput of the cell.

9. The method of claim 8, wherein the load balancing policy includes a weighted combination of two or more of:
a prioritization of a DL capacity across the plurality of frequency carriers;
a prioritization of a UL capacity across the plurality of frequency carriers;
a prioritization of UL resources on at least one low band frequency carrier of the plurality of frequency carriers;
a prioritization of DL resources on at least one mid-band frequency carrier of the plurality of frequency carriers; and
a prioritization of DL resources on at least one high-band frequency carrier of the plurality of frequency carriers.

10. The method of claim 1, wherein determining the resource configuration includes assigning all UL resources and all DL resources on a first frequency carrier of the plurality of frequency carriers prior to activating a second frequency carrier of the plurality of frequency carriers.

11. The method of claim 1, wherein the method further comprises:
determining a beamforming configuration for at least one frequency carrier, the beamforming configuration extending a range of at least one coverage region based on an additional UL capacity requirement of at least one WD located near an edge of the cell.

12. The method of claim 1, wherein the method further comprises:
determining a first beamforming configuration for a first frequency carrier, the beamforming configuration being configured to minimize interference between the first frequency carrier in the cell and the first frequency carrier in a neighboring cell, the first beamforming configuration being orthogonal to a second beamforming configuration of the neighboring cell.

13. The method of claim 1, wherein the determining of the resource configuration includes
prioritizing a DL capacity across the plurality of frequency carriers based on a neighboring cell prioritizing an UL capacity.

14. A network node configured to communicate with a plurality of wireless devices, WDs, in a cell using at least one of a plurality of frequency carriers, the network node comprising processing circuitry configured to:
determine a plurality of coverage regions based on an uplink, UL, demand and a downlink, DL, demand associated with the cell, each of the plurality of coverage regions being associated with one corresponding frequency carrier of the plurality of frequency carriers;
determine a mapping of each of the plurality of WDs to at least one corresponding coverage region of the plurality of coverage regions based on location information associated with each of the plurality of WDs;
determine a ranking for the plurality of WDs based on the mapping and on priority information associated with each of the plurality of WDs;
determine a resource configuration for the plurality of WDs in the cell based on the ranking; and
one or both of receive from and transmit to a first WD of the plurality of WDs according to the resource configuration.

15-26. (canceled)

27. A method in a wireless communication system including a network node configured to communicate with a plurality of wireless devices, WDs, in a cell using at least one of a plurality of frequency carriers, the method comprising:
determining a plurality of coverage regions based on an uplink, UL, demand and a downlink, DL, demand associated with the cell each of the plurality of coverage regions being associated with one corresponding frequency carrier of the plurality of frequency carriers;
determining mapping of each of the plurality of WDs to at least one corresponding coverage region of the plurality of coverage regions based on location information associated with each of the plurality of WDs;
determining a ranking for the plurality of WDs based on the mapping and on priority information associated with each of the plurality of WDs;
determining a resource configuration for the plurality of WDs in the cell based on the ranking; and
one or both of receiving from and transmitting to a first WD (22) of the plurality of WDs according to the resource configuration.

28-52. (canceled)

53. The method of claim 1, wherein the determining of the ranking for the plurality of WDs includes:
ranking the first WD of the plurality of WDs higher than another WD of the plurality of WDs based on the first WD being farther from a center of the cell compared to the other WD according to an electrical distance, the electrical distance being determined based on at least one reference signal associated with at least one of the first WD and the other WD.

54. The method of claim 8, wherein the load balancing policy is configured for optimizing an overall capacity of the cell.

55. The method of claim 8, wherein the load balancing policy is configured for optimizing an average throughput of the cell.

56. The method of claim 8, wherein the load balancing policy includes a weighted combination of:
a prioritization of a DL capacity across the plurality of frequency carriers;
a prioritization of a UL capacity across the plurality of frequency carriers;
a prioritization of UL resources on at least one low band frequency carrier of the plurality of frequency carriers;
a prioritization of DL resources on at least one mid-band frequency carrier of the plurality of frequency carriers; and
a prioritization of DL resources on at least one high-band frequency carrier of the plurality of frequency carriers.

57. The method of claim 1, wherein the determining of the resource configuration includes prioritizing a UL capacity across the plurality of frequency carriers based on the neighboring cell prioritizing a DL capacity.
